(19) United States
(12) Patent Application Publication
(10) Pub. No.: US 2005/0114457 A1
(43) Pub. Date: May 26, 2005

(54) Filtering device for eliminating unsolicited email

(76) Inventor: Meng-Fu Shih, Taipei (TW)

Correspondence Address: DELLETT AND WALTERS, P. O. BOX 2786, PORTLAND, OR, 97208-2786, US

(21) Appl. No.: 10/970,097

(22) Filed: Oct. 20, 2004

(30) Foreign Application Priority Data
Oct. 27, 2003 (TW) 092219035

(51) Int. Cl. G06F 15/16

(52) U.S. Cl. 709/206; 713/200

(57) ABSTRACT

A filtering device for determining and disposing of unsolicited emails is mounted at a front end of a mail server of a company. A filtering engine will compare and filter all the received emails. The filtering engine has an online mode filtering module, a black-list filtering module, a specified content comparing module and a conditional content comparing module, all of which are cooperating together to increase the veracity of email judgment.

### BACKGROUND OF THE INVENTION

1. Field of the Invention

The present invention relates to a filtering device for eliminating unsolicited email, and particularly relates to a filtering device that is not only able to eliminate unsolicited email, but also provides interfaces, through which the users can actively adjust some function of the device when in practice.

2. Description of Related Art

Emailing has revolutionized written communications but nearly all the internet users suffer from unsolicited, undesired, nuisance emails. This is an extremely irritating situation as not only is the mail offensive in its failure to respect peoples' privacy, it can often jam an email box because of the large size of the mails and so a user then cannot receive desired, genuine emails. The email senders can easily send a lot of emails by some email-sending software, while the email receivers have to spend a large amount of time dealing with these emails. Although some email filtering devices are popular in the market, the junk email senders can always find the backdoors of the filtering device, so that the email preventing function becomes ineffective.

Therefore, the invention provides a filtering device which eliminates unsolicited, nuisance email to mitigate or obviate the aforementioned problems.

### SUMMARY OF THE INVENTION

The main objective of the present invention is to provide a multi-functional filtering device to eliminate unsolicited junk emails. The junk emails are classified into several groups based on their respective styles and a comparing database is built up to increase the email elimination efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a block system diagram in accordance with this invention;

FIG. 2 is a block diagram of a filtering engine in accordance with this invention;

FIG. 3 is a block diagram of a conditional content comparing module in the filtering engine in accordance with this invention; and

FIG. 4 is a block diagram of a keyword-based comparing unit in the conditional content comparing module in accordance with this invention.

### DETAILED DESCRIPTION OF THE PREFERRED EMBODIMENT

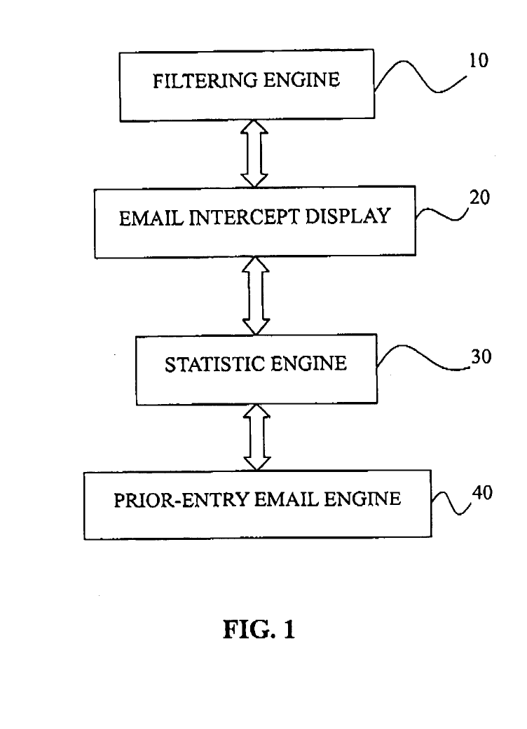

FIG. 1 shows a block system diagram of this invention composed of a filtering engine (10) to eliminate the unsolicited emails in received emails, thus the unsolicited emails are denied entry while genuine, desired mails are unimpeded. An email intercept display (20) is responsible for the arrangement of the rejected emails, and sends the accumulated such emails to the receiver every certain time to facilitate the checking of the emails by the receiver. Of course, the receiver can also enter the intercept email display (20) to skim through the rejected emails to actively commit the management of the emails. A statistic engine (30) is applied to provide data charts to be analyzed by the receiver. A white-list filtering engine (40) is used for permitting entry by some genuinely important emails.

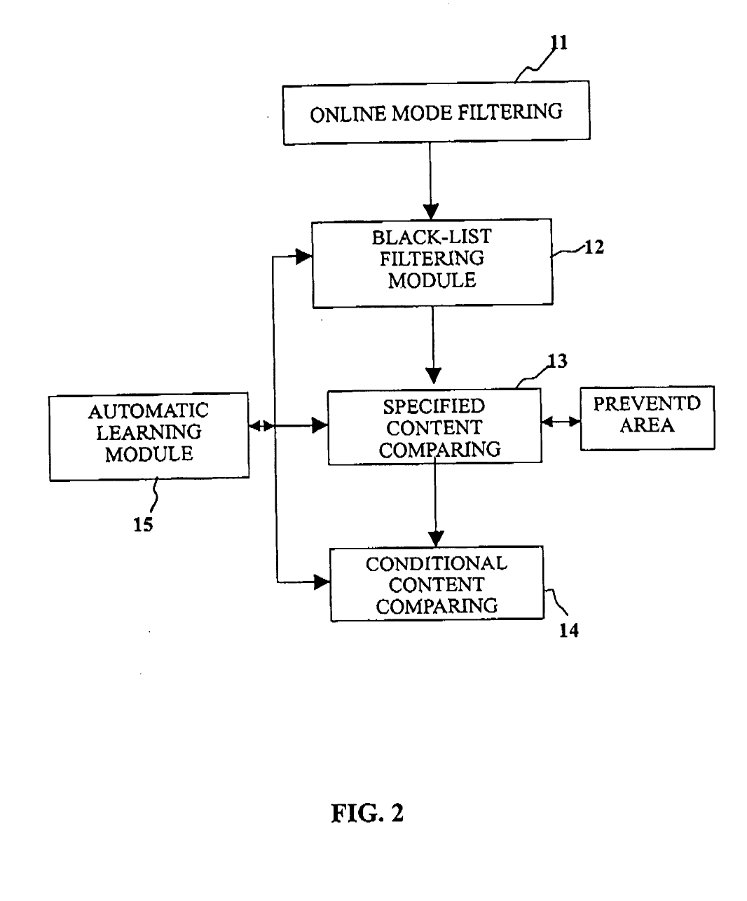

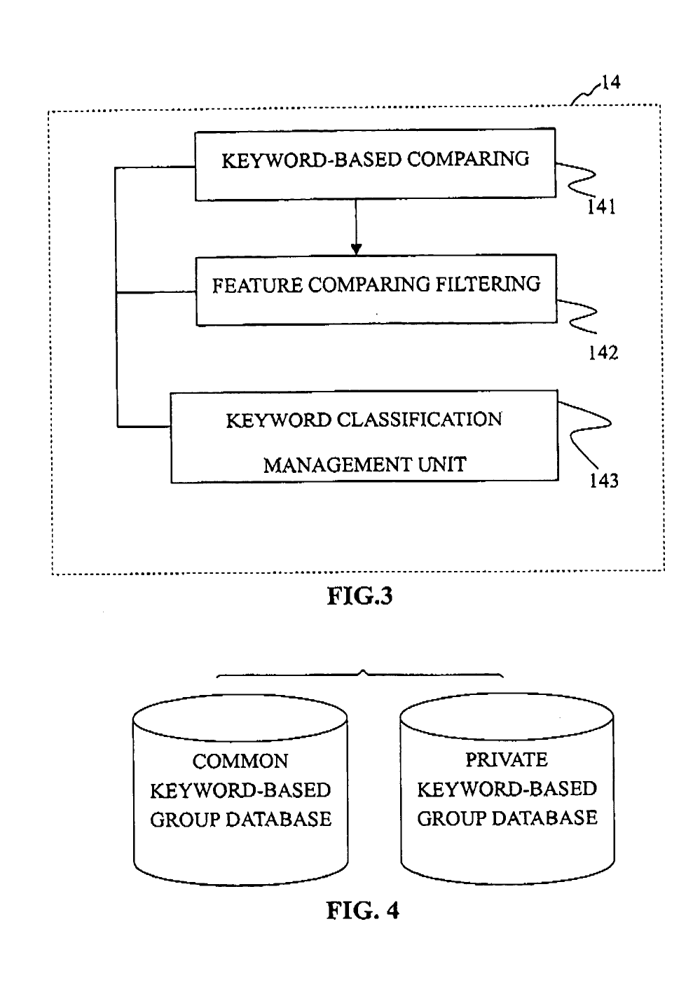

As shown in FIG. 2, the filtering engine (10) has an online mode filtering module (11) for checking the abnormal online connection. Any abnormal connection will be automatically recorded in the black-list. In this embodiment, the online mode filtering module (11) consists of a DoS defensive filter. A general DoS defensive filter can prevent an instant email flood based on the bottom layer communication protocol via a network adapter card or predetermine a black-list to directly refuse the email flood. In this invention, the DoS defensive filter will connect to the Port 25 at the moment of filtering, and once the accumulated emails in a certain time period exceeds a reasonable amount, the defensive filter will be activated and add the related addresses to the black-list. In addition, the black-list can be set as being invalid or permanently valid or fully automatic.

A black-list filtering module (12) is mainly used to recognize the sender, IP and Domain of the unsolicited emails and refuse them directly without further judgment. To avoid rejecting useful emails by mistake, a white-list is also built to record the trusted partners' emails, which can pass without any judgment.

A specified content comparing module (13) is responsible for distinguishing emails with specified letters or words, which can more effectively prevent the unwanted emails and facilitate centralized management of some specified letters.

A conditional content comparing module (14) is used to conclude most unsolicited email styles based on experience of previous such emails, further cooperating with weighting operation to increase the veracity of email judgment, meanwhile, a comparing database is built up.

An automatic learning module (15) is responsible for accepting the sample emails and learning their characteristics, and then it proceeds with intelligent management of emails. If there are many sample undesired emails received therein, the automatic learning module (15) will remember the characteristics of those emails as a base for subsequent filtering exercises.

The conditional content comparing module (14) is further composed of a keyword-based comparing unit (141) which can filter some kinds of emails based on most keywords in previous emails, but the email only has pictures or hyperlinks which can not be recognized by the keyword-based comparing unit (14). A feature comparing filtering unit (142) cooperates with the keyword-based comparing unit (141) which can recognize the unrequited emails only having pictures or hyperlinks. A keyword classification management unit (143) can classify the keywords into different groups to meet the requirement of each section in the company.

The keyword-based comparing unit (141) consists of a common keyword-based group database and a private keyword-based group database. In the former database, the Chinese sample undesired emails are classified into different groups to abstract the keywords of different groups, each keyword being distributed a value; a weighting value will be added to a sum of these values to obtain a threshold value. Once the accumulated value of keywords passes the threshold value, the corresponding email will be marked as undesired email and thrown into an email bin. The frequency and value of each keyword can be seen in the email bin. The latter database adapted to the users' requirement can define a private keyword database. When a new type of unsolicited email is developed and which can not be checked by the common keyword-based group database, the user can send this email to an “email callback” with an individual definition.

In addition, the feature comparing filtering unit (142) provides a special weighting value to enhance the filtering function. In the special weighting value, the following filtering rules are added:
1. A sender shown in the email is not the real sender based on SMTP (simple mail transfer protocol) protocol. A deceitful email sender may forge a sender ID to trick the recipient.
2. A receiver shown in the email is not the user. A junk email sender may forge a receiver to cause curiosity, ie an actual receiver may believe an incorrect address was used and be sufficiently intrigued to open the mail.
3. A receiver in the email is not disclosed. The email with unidentified receiver is filtered.
4. Weighting value of the keyword in the major part is multiplied. Some undesired emails have only a few letters or even no letters, but the email keywords are obvious in the major part, thus the weighting value will be multiplied.
5. The major part is 8 characters between English letters. Some emails are covered up by that way to avoid keyword-based filtering.
6. Plain picture links. Some emails have a lot of plain picture links to avoid keyword-based filtering.
7. Abnormal HTML (Hypertext Markup Language) recognition. A lot of undesired emails adopt the HTML volume labels to emphasize their product advertisement. HTML TAG operation is adopted in this invention.

Whether each of the above rules is to be activated can be determined by the users, and the value of each rule is also predetermined by the users. The special value will be together with keyword-based comparing method to be recognized by conditional content comparing method. Each rejected email will be distributed to a corresponding group; if the junk email has only a plain picture or hyperlinks that can not be detected by the keyword-based method, as long as an accumulated value of the special weighting exceeds that of other type of advertisement email, the special weighting email will be rejected and marked as a kind of advertisement email.

Generally, the unsolicited emails will be thrown away or put in a certain place, and then the user will decide how to deal with such emails. However, some vital email may be inevitably classified as undesired email. Filtered by specified content comparing module (13) and conditional content comparing module (14), all the unsolicited emails are recorded and displayed by the email intercept display (20). The caught email will be deposited safely in the host computer.

In addition to the email manager, the rejected emails can be classified into different groups, which are open to different users respectively, thus the user can check the rejected emails based on their respective requirement. Such kind of function not only considers individualization, but also shares the tasks of the email manager.

The statistic engine (30) provides a statistical chart automatically drawn thereby, which facilitates the checking of an email flow capacity, an unsolicited email flow capacity, re-post email statistics, email source statistics and DoS online attack times statistics.

The above statistic engine (30) can be activated every day, every week, every month or at a certain period set by the user, moreover, the statistic result can be reordered based on the requirement.

As the user may have a certain type of important emails, the white-list filtering engine (40) will let such kind of emails get through according to a predetermined parameter. In this way, the important email will not be filtered by mistake.

1. A filtering device for determining and disposing of unsolicited email, and having a filtering engine to filter the unsolicited emails from the internet servers, wherein the filtering engine comprises:
an online mode filtering module detecting an online mode of the emails, once an abnormal online mode connection is detected, the corresponding emails will be exiled to a black-list;
a black-list filtering module, wherein a sender of an email, IP and the Domain of the unsolicited emails are recognized and rejected; a specified content comparing module detecting the unsolicited emails with obvious special letters or characters; and
a conditional content comparing module concluding most of the unsolicited emails style and a comparing database built up therein.

2. The filtering device for determining and disposing of unsolicited emails as defined in claim 1, wherein the online mode filtering module is performed by a DoS defensive filter.

3. The filtering device for determining and disposing of unsolicited emails as defined in claim 1, wherein the black-list filtering module not only sets a black-list to prevent the related emails directly, but also sets a whitelist to let the related emails be directly accepted by a mailbox.

4. The filtering device for determining and disposing of unsolicited emails as defined in claim 11, wherein the conditional content comparing module comprises:
a keyword-based comparing unit filtering most junkunsolicited emails with obvious keywords of junkunsolicited emails and providing special weighting value based on the junkunsolicited email character to reject prevent the escaped junknon-detected unsolicited emails; and
a feature comparing filtering unit detecting the junkunsolicited emails with plain pictures or hyperlink which can not be recognized by the keyword-based comparing unit.

5. The filtering device for determining and disposing of unsolicited emails as defined in claim 4, wherein the comparing database used by the keyword-based comparing unit is composed of a common keyword-based group database, wherein the unsolicited emails using Chinese characters are classified into different groups as samples to abstract the keywords of different groups, and each keyword will be distributed a value, sum of these values will have added thereto a weighting value to obtain a threshold value, once the accumulated value passes the threshold value, the corresponding email will be determined to be unsolicited email and exiled into a bin for unsolicited emails; and
a private keyword-based group database defined beforehand based on the users' requirement.

6. The filtering device for determining and disposing of unsolicited emails as defined in claim 4, wherein the conditional content comparing module further comprises a keyword classification management unit which can distribute the keywords into different groups adapted to the different sections in a company

7. The filtering device for determining and disposing of unsolicited emails as defined in claim 1, wherein the filtering engine further comprises an automatic learning module which can recognize new type junkunsolicited emails from email samples.

8. The filtering device for determining and disposing of unsolicited emails as defined in claim 1 further comprising an email intercept display to arrange and send the junkunsolicited emails in batches to the original receiver per a certain time period, wherein the junkunsolicited emails will be checked by the receiver; and a statistic engine provides related statistical chart analyzed by the email manager.

9. The filtering device for determining and disposing of unsolicited emails as defined in claim 8, wherein the statistic engine automatically draws the statistical chart, thus an email flow capacity, a rejected prevented junk emails flow capacity, a re-post junkunsolicited email statistics, a email source statistics and an online attack times statistics isare checked clearly by the users.

10. The filtering device for determining and disposing of unsolicited emails as defined in claim 1 further comprises a white rule filtering engine which lets the emails in accordance with the white rule be accepted by an emailbox.
